(19) United States
(12) Patent Application Publication
(10) Pub. No.: US 2013/0136152 A1
(43) Pub. Date: May 30, 2013

(54) PASSIVE TEMPERATURE SENSOR

(71) Applicant: Fraunhofer-Gesellschaft, Munich (DE)

(72) Inventors: Tobias DRAEGER, Baiersdorf (DE); Josef BERNHARD, Nabburg (DE)

(73) Assignee: Fraunhofer-Gesellschaft, Munich (DE)

(21) Appl. No.: 13/686,188

(22) Filed: Nov. 27, 2012

(30) Foreign Application Priority Data
Nov. 28, 2011 (DE) 10 2011 087 262.0

(51) Int. Cl. G01K 7/00

(52) U.S. Cl. CPC G01K 7/00
USPC 374/183

(57) ABSTRACT

A passive temperature sensor with cordless measurement signal transmission includes: a coupling element that is implemented to draw electric energy from a magnetic or electromagnetic alternating transmission field; an energy rendering element that is implemented to provide an energy supply signal based on the drawn electric energy; a temperature measurement circuit that is implemented to generate, when supplied with the energy supply signal, a sensor alternating signal whose frequency depends on an environmental temperature; and a switching element that is implemented to change, based on the sensor alternating signal, a physical characteristic allocated to the coupling element to obtain an impact on the alternating transmission field based on the sensor alternating signal.

### CROSS-REFERENCE TO RELATED APPLICATIONS

This application claims priority from German Patent Application No. 102011087262.0, which was filed on Nov. 28, 2011, and is incorporated herein in its entirety by reference.

### BACKGROUND OF THE INVENTION

Embodiments of the present invention relate to a passive temperature sensor with cordless measurement signal transmission and to a reading device for passive temperature measurement. In particular, embodiments relate to a passive temperature sensor with cordless (conductor-independent) measurement signal transmission by means of load modulation at inductive coupling.

Temperature sensors serve the purpose of outputting machine-processable measurement signal based on the measured environmental temperatures. This measurement signal can, for example, be a digital or analog signal. Temperature sensors are used in different technical fields of application, for example automotive engineering. Here, depending on the field of application, different demands are made on the temperature sensors with respect to temperature measurement range and environmental conditions.

### SUMMARY

According to an embodiment, a passive temperature sensor with cordless measurement signal transmission may have: a coupling element that is implemented to draw electric energy from a magnetic or electromagnetic alternating transmission field, an energy rendering element that is implemented to provide an energy supply signal based on the drawn electric energy, a temperature measurement circuit that is implemented to generate, when supplied with the energy supply signal, a sensor alternating signal whose frequency depends on an environmental temperature, a switching element that is implemented to change, based on the sensor alternating signal, a physical characteristic allocated to the coupling element to obtain an impact on the alternating transmission field based on the sensor alternating signal.

According to another embodiment, a reading device for passive temperature measurement may have: a read-coupling element that is implemented to provide a magnetic or electromagnetic alternating transmission field to detect an impact on the alternating transmission field effected by an inventive passive temperature sensor; and an evaluation means that is implemented to determine temperature information on the environmental temperature of the passive temperature sensor based on the effected impact on the alternating transmission field or to output an output signal based on the effected impact on the alternating transmission field from which the temperature information on the environmental temperature of the passive temperature sensor can be derived.

It is the core of the present invention to implement a passive wirelessly readable temperature sensor, i.e. a temperature sensor that can be energized in a cordless manner, and where further the temperature measurement signal can be read out wirelessly (cordlessly) at sufficient external energy supply. The passive temperature sensor is activated and energized via a magnetic or electromagnetic alternating transmission field, i.e. from the outside. Here, the passive temperature sensor is coupled to the alternating transmission field by means of a coupling element, e.g. a transmission coil or antenna having a defined physical characteristic, such as an impedance or load resistance. Measuring the environmental temperature is effected by means of a temperature measurement circuit of the temperature sensor generating a temperature dependent sensor alternating signal as output signal during activation, i.e. at sufficient energy supply. The temperature measurement circuit is implemented to generate the temperature dependent sensor alternating signal, such that a predetermined or known connection between the frequency of the sensor alternating signal and the environmental temperature to be measured exists. This sensor alternating signal will now be used to specifically change the physical characteristic of the coupling element. This change can, for example, be detected from the outside by means of a load modulation or modulated backscatter of the alternating transmission field, whereby conclusions on the environmental temperature measured by the temperature sensor become possible via the detected frequency of the sensor alternating signal. Detection is performed by means of a reading device determining the measured environmental temperature based on the impact or influence on the alternating transmission field by the passive temperature sensor. At the same time, this reading device wirelessly energizes the passive temperature sensor, i.e. via the inductively coupled alternating transmission field generated by the reading device.

According to embodiments, temperature measurement of the temperature measurement circuit is based on the fact that a switching behavior of the temperature measurement circuit or a switching behavior of transistors or field-effect transistors of the temperature measurement circuit varies in dependence on the environmental temperature. The transistors or field-effect transistors of the temperature measurement circuit can, for example, be connected such that they generate the sensor alternating signal, e.g. a square-wave signal, sinus signal, pulse signal or other periodic signal from the waveform of which a temperature can be derived. During a change of the environmental temperature, the switching behavior of the field-effect transistors changes such that the frequency of the generated sensor alternating signal changes in dependence on the change of the environmental temperature.

Embodiments of the present invention provide a passive temperature sensor with cordless measurement signal transmission. The same comprises a coupling element that is implemented to draw electric energy from a magnetic or electromagnetic alternating transmission field. Further, the same comprises an energy rendering element that is implemented to provide an energy supply signal, such as voltage or current strength, based on the drawn electric energy. Further, the passive temperature sensor comprises a temperature measurement circuit, e.g. a multi-vibrator circuit that is implemented to generate, at sufficient supply with the energy supply signal, a transmission alternating signal whose frequency depends on an environmental temperature. A switching element of the passive temperature sensor is implemented to change, based on the sensor alternating signal, a physical characteristic allocated to the coupling element, such as a load resistance value or impedance value to obtain, based on the sensor alternating signal, an impact on the alternating transmission field that can be detected from the outside for temperature information. Here, it is advantageous that such passive temperature sensors can also be used at high temperatures, e.g. >150° C. Embedding the same in thin layers that might also be conductive or weakly conductive (e.g. carbon fiber composites) is possible. Further, it is advantageous that such a temperature measurement circuit has low energy consumption, so that no separate energy storage is necessitated, but energy supply is effected, for example based on a magnetic or electromagnetic alternating transmission field provided by a reading device for passive temperature measurement. By supplying the passive temperature sensor with energy of the alternating transmission field and by omitting an energy storage, the passive temperature sensor can also be used at high temperatures, for example up to 150° C. or 300° C. or, advantageously in a range between −40° C. and 200° C. where conventional energy storages, such as a battery or an accumulator, cannot be used.

According to embodiments, information transmission with respect to the environmental temperature is effected by modulating the transmission alternating signal onto the alternating transmission field by means of the coupling element. Here, the switching element of the passive temperature sensor that is energized by means of inductive coupling by a magnetic alternating transmission field in the near field (for example at a distance of 1 mm to 1 m) is implemented to perform load modulation of the magnetic alternating transmission field based on the sensor alternating signal by changing the load resistance. Here, it is advantageous that the sensor alternating signal can be modulated directly onto the alternating transmission field, i.e. without post-processing, e.g. by means of digitalization, which reduces the complexity and interference liability of the passive temperature sensor.

According to further embodiments, the switching element of the passive temperature sensor which is energized in the far field (i.e. with a distance>1 m or in a range of 1 to 3 m) of an electromagnetic alternating transmission field, can be implemented to perform modulated backscatter of the electromagnetic alternating transmission field based on the sensor alternating signal by changing the impedance value, and to provide the temperature information to the reading device in that manner. In such temperature sensors using modulated backscatter for temperature information transmission, there are also the advantages that circuit complexity and thus liability are very low. Further, this operating mode allows the passive temperature sensor to be operable even in the far field of the reading device. Due to the lower energy density of the electromagnetic alternating transmission field in the far field, the passive temperature sensor can be implemented, for example, as integrated circuit characterized by very low energy requirements.

According to a further embodiment, the invention provides a reading device for passive temperature measurement. This reading device comprises a read-coupling element that is implemented to provide a magnetic or electromagnetic alternating transmission field to detect an impact on the alternating transmission field, such as a load modulation or modulated backscatter, effected by a passive temperature sensor. Further, the reading device comprises an evaluation means that is implemented to calculate temperature information on the environmental temperature of the passive temperature sensor based on the effected impact on the alternating transmission field. Here, for example, a lookup table can be used, including information on an allocation between the frequency of the sensor alternating signal modulated onto the alternating transmission field and the measured environmental temperature. Here, it is advantageous that the reading device provides, on the one hand, energy for the passive temperature sensor and, on the other hand, detects the impact on the alternating transmission field as temperature information. Detection and evaluation are characterized by low complexity since no extensive post-processing, for example, by decoding is necessitated.

### BRIEF DESCRIPTION OF THE DRAWINGS

Embodiments of the present invention will be detailed subsequently referring to the appended drawings, in which:

FIG. 1 is a schematic illustration of a passive temperature sensor with cordless measurement signal transmission according to an embodiment;

FIG. 2a is a schematic illustration of an inductive coupling in the near field between a passive temperature sensor and reading device according to an embodiment;

FIG. 2b is a schematic illustration of an electromagnetic coupling in the far field between a passive temperature sensor and a reading device according to an embodiment;

FIG. 3 is a schematic circuit diagram of a temperature measurement circuit according to an embodiment; and

FIG. 4 is a schematic diagram of a passive temperature sensor with cordless measurement signal transmission according to an embodiment.

### DETAILED DESCRIPTION OF THE INVENTION

Before embodiments of the present invention will be discussed in detail based on the drawings, it should be noted that identical, functionally equal or equally effective elements in the different figures are provided with the same reference numbers, such that the description of the elements and structures provided with the same reference numbers in the different embodiments are interchangeable or can be applied to one another.

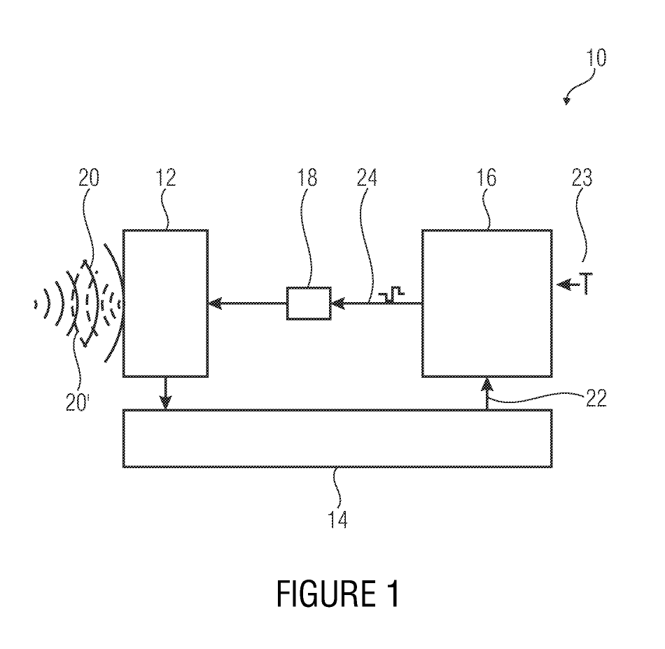

FIG. 1 shows a passive temperature sensor 10 with cordless measurement signal transmission. The passive temperature sensor 10 comprises a coupling element 12, an energy rendering element 14, a temperature measurement circuit 16 and a switching element 18.

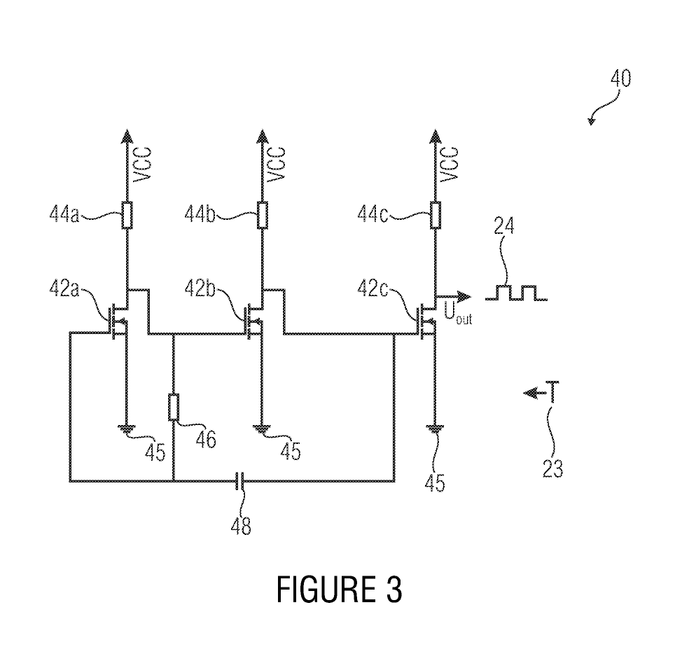

The coupling element 12 is implemented to draw energy from a magnetic or electromagnetic alternating transmission field 20. This electrical energy is provided to the temperature measurement circuit 16 as energy supply signal 22 by means of the energy rendering element 14 for energy supply. The temperature measurement circuit 16 comprises, for example a multi-vibrator circuit, a flip-flop circuit or an oscillator circuit having a switching behavior depending on an environmental temperature 23, based on which the environmental temperature 23 is determined. The temperature-dependent switching behavior can be implemented, for example, by one or several transistors or field-effect transistors of the temperature measurement circuit 16, wherein the gate source voltage for gating the channel varies in dependence on the environmental temperature 23, as will be explained in detail in FIG. 3. As a consequence, at sufficient energy supply, the temperature measurement circuit 16 outputs a sensor alternating signal 24, such as a square-wave signal, sinus signal, sawtooth signal or impulse signal whose frequency depends on the environmental temperature 23. This is realized, for example, in that the temperature measurement circuit 16 comprises two astable states, switching back and forth with a frequency that is all the higher, for example with increasing environmental temperature 23. Thus, a temperature-dependent impact on the frequency of the sensor alternating signal 24 or the square-wave signal results. Based on this sensor alternating signal 24, the switching element 18 changes a physical characteristic, such as a load resistance value or an impedance value of the coupling element 12 to obtain an impact 20′ on the sensor alternating field 20 based on the sensor alternating signal 24.

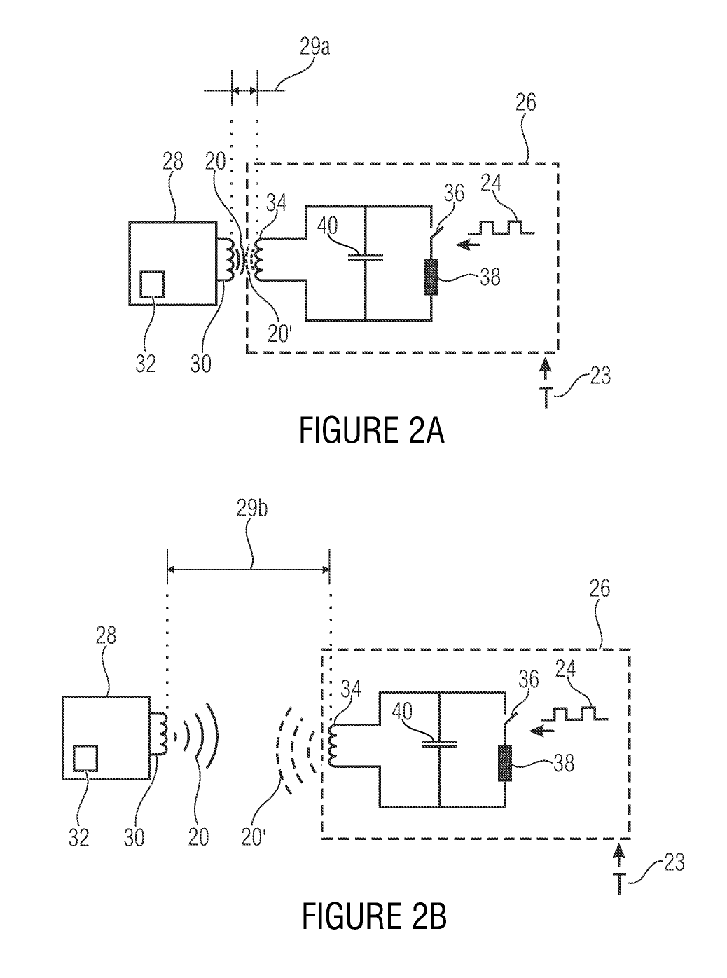

The impact 20′ on the alternating transmission field 20 can be detected from the outside, for example by means of a reading device (not shown), such that the sensor alternating signal 24 or the frequency of the sensor alternating signal 24 allowing direct conclusions on the environmental temperature 23 determined by the temperature measurement circuit 16 can be read out. The impact 20′ on the alternating transmission field 20 is effected by modulating the sensor alternating signal 24 onto the magnetic or electromagnetic alternating transmission field 20. In the near range, the impact 20′ on the magnetic alternating transmission field 20 can be effected by means of load modulation by changing a load resistance of the coupling element 12. In the far range, the impact 20′ on the electromagnetic alternating transmission field 20 is effected by means of modulated backscatter of the alternating transmission field 20 by changing an impedance value of the coupling element 12. The impact 20′ on the magnetic or electromagnetic alternating transmission field 20 will be discussed in more detail below with reference to FIGS. 2a and 2b.

FIG. 2a shows a passive temperature sensor 26 and a reading device 28 that are inductively coupled to one another in the near field. The reading device 28 comprises a read-coupling element 30, such as a coil, and an evaluation means 32. The reading device 28 is positioned opposite to the passive temperature sensor 26 with a distance 29a. The passive temperature sensor comprises a coil 34 as coupling element as well as a switching element 36 connecting or short-circuiting a first side of the coil 34 to a second side of the coil 34 across a load resistance 38. Further, an optional capacitor 40 is connected in parallel to the coil 34.

In this embodiment, the passive temperature sensor 26 is operated in the near range or near field, i.e. at a distance 29a, e.g. between 1 mm and 3 m. The near field is defined in that the distance between read-coupling element 30 and coupling element or coil 34 is small (e.g. distance 29a<frequency/2π) compared to the used wavelength of the magnetic alternating transmission field which is, for example, in the low frequency range between 100 and 135 kHz or in the high frequency range between 6.78 MHz and 27.125 MHz.

By outputting the magnetic alternating transmission field 20 by means of the read-coupling element 30, the reading device 28 provides energy to the passive temperature sensor 28. This energy is drawn from the magnetic alternating transmission field 20 by the coil 34 and is provided to the temperature measurement circuit (not shown) by means of the energy rendering element (not shown). As described above, at (sufficient) energy supply, the same outputs the sensor alternating signal 24 depending on the environmental temperature 23, by means of which the switching element 36 is controlled such that the load resistance 38 is connected periodically in series with the coil 34. Hereby, based on the sensor alternating signal 24, a change or periodic change of the load resistance value of the coil 34 results, such that load modulation of the magnetic alternating transmission field 20 is performed by means of the coil 34. In detail, the load modulation effects a voltage change in the coil 34 when switching on or off the switching element 36, wherein the voltage change takes place with the frequency of the sensor alternating signal 24. The voltage change or frequency of the voltage change in the coil 34 can be detected by the reading device 28. In other words, the switching element 36 switches a load 38 onto the coil 34 or the coupling element, also called secondary coil, whereby the auxiliary carrier with the frequency of the current sensor alternating signal 24 results, for transmitting the same by modulating onto an auxiliary carrier of the magnetic alternating transmission field 20. Thus, the directly readable frequency of the transmission alternating signal 24 or the auxiliary carrier itself presents the signal quantity to be evaluated, without digitalization or encoding of the sensor value 24. The optional capacitor 40 allows to operate an oscillator circuit, formed by coil 34 and capacitor 40, in resonance, and thus to improve the coupling of the alternating transmission field 20 and the load modulation.

The evaluation means 32 of the reading device 28 is implemented to calculate the environmental temperature 23 of the passive temperature sensor 26 based on the effected impact 20′ on the alternating transmission field 20 or the load modulation. For this, the effected impact 20′ on the alternating transmission field 20 is detected by the read-coupling element 30 and analyzed by the evaluation means 32. According to further embodiments, calculation is performed by an envelope modulator of the evaluation means 32 determining the frequency of the sensor alternating signal 24. To infer the environmental temperature 23 from the determined frequency of the sensor alternating signal 24, a lookup table can be used, which comprises information on an allocation between a respective frequency of the sensor alternating signal 24 and the measured environmental temperature 23 of the passive temperature sensor 26. Such a lookup table can be determined for the respective passive temperature sensor 26 during calibration.

Alternatively, the evaluation means 32 of the reading device 28 can be implemented to convert a frequency signal determined based on the effected impact 20′ on the transmission alternation field 20 into an output signal, such as a voltage signal, and to provide the same. Conversion can be performed by means of f/U conversion (with f=frequency depending on the sensor alternating signal 24 and U=voltage as output signal), based, for example, on rectification and buffering of the frequency signal.

During f/U conversion, scaling of the output signal can be effected, such that the obtained output signal corresponds (at least in certain areas) to an output signal and a characteristic curve of a resistance temperature sensor, such as a PTC (Positive Temperature Coefficient, e.g. PT100 or PT1000) or an NTC (Negative Temperature Coefficient). Consequently, the connection between the output signal and the determined environmental temperature 23 corresponds at least in parts to a connection of a standardized resistance temperature sensor. This is advantageous since in that way the reading device 28 outputs a predefined or standardized output signal which can be directly processed further, independent of the temperature sensor that determines the environmental temperature 23.

FIG. 2b shows the passive temperature sensor 26 and the reading device 28 according to FIG. 2a, wherein the passive temperature sensor 26 is in the far region or far field of the reading device 28, i.e. that a distance 29b, e.g. more than 3 m or in the range of 2 m to 5 m between the passive temperature sensor 26 and the reading device 28 is several wave lengths of the operating frequency. During operation in the far field (e.g. distance 29b>frequency/2π), the frequency is typically in a frequency range of 868 MHz and 2.45 GHz.

In the far field, the electric energy is provided by means of an electromagnetic alternating transmission field 20, onto which the sensor alternating signal 24 will be modulated as well, as will be described in more detail below. In this embodiment, the switching element 36 of the passive temperature sensor 26 is implemented to effect, based on the sensor alternating signal 24, a change or periodic change of the impedance value of the coil 34 by switching on and off the load resistance 38 and to effect an impact 20′ on modulated backscatter of the electromagnetic alternating transmission field 20 by means of the coil 34. In other words, during resonance, the alternating transmission field is reflected to the reading device 28 with the frequency of the transmission alternating signal 24 by the coil 34 (in combination with the optional capacitor 40) (backscatter method). Here, it is advantageous that the electric energy and the sensor alternating signal 24 can be transmitted across the distance 29b, which is larger than the distance 29a according to FIG. 2a.

With reference to FIGS. 2a and 2b, it should be noted that the coupling element or read-coupling element 30, described as coils (cf. coil 34) in the above-described embodiments, can alternatively also be implemented as antenna or dipole antenna. A coupling element implemented as antenna has the advantage that directional coupling to the reading device 28 can take place.

FIG. 3 shows a multi vibrator circuit 40 having three transistors 42a, 42b and 42c. Transistors 42a, 42b and 42c are, for example, field-effect transistors. Generally, field-effect transistors have a switching behavior depending on the environmental temperature 23, wherein the same can take a different shape, depending on the used type. Each of the three transistors 42a, 42b and 42c is connected by an input terminal or source contact, each via a transistor 44a, 44b and 44c, to the energy rendering element (not shown). With this output terminal or drain contact, the three transistors 42a, 42b and 42c are each connected to a common reference potential 45 of the passive temperature sensor. A control terminal or gate contact of the first transistor 42a is connected, via a transistor 46, to the input terminal of the same transistor and a control terminal of the second transistor 42b. Further, the control terminal of the first transistor 42a is coupled to an input terminal of the second transistor 42b and a control terminal of the third transistor 42c via a capacitor 48. As a consequence, the control terminal of the third transistor 42c is coupled to the input terminal of the second transistor 42b and the control terminal of the second transistor 42b is coupled to the input terminal of the first transistor 42a.

Due to this mutual coupling via resistor 46 and capacitor 48, at sufficient energy supply VCC (between input and output terminals of transistors 42a, 42b, 42c), either the transistor 42a or the transistor 42b is conductive, such that the temperature measurement circuit 40 has two astable states. By the connection of the control terminal of the third transistor 42c, the same becomes non-conductive when the second transistor 42b is non-conductive, and conductive when the first transistor 42a is non-conductive. Hereby, the sensor alternating signal 24 can be output, for example, in the form of a square-wave voltage or square-wave signal at the input terminal of the third transistor 42c. Thus, the duration of the astable states of the transistors 42a and 42b directly influences the frequency of the center alternating signal 24. Since the gate-source voltage (e.g. in the range of 0.1 V and 4.0 V or −0.1 V and −4.0 V, depending on transistor type) between the control terminal and the output terminal of the two transistors 42a and 42b depends on the environmental temperature 23, the environmental temperature influences the duration of the astable states and hence the frequency of the sensor alternating signal 24. This connection shows in that the transistors 42a and 42b connect the channel through at a lower gate-source voltage, e.g. at 2.9 V instead of 3.1 V at higher environmental temperatures 23, i.e. that gating the respective transistors 42a and 42b takes place earlier. In that way, the frequency of the sensor alternating signal 24 increases with increasing environmental temperature 23.

Alternatively, according to further embodiments, the temperature measurement circuit 40 can also be implemented as flip flop circuit or oscillator circuit or any other electric circuit, having a switching behavior depending on the environmental temperature 23, such that the temperature measurement circuit generates a sensor alternating signal 24 whose frequency depends on the environmental temperature 23.

Thus, according to further embodiments, the temperature measurement circuit 40 comprises at least one or advantageously at least two transistors or field-effect transistors having a switching behavior depending on the environmental temperature 23, which are each connected to the energy rendering element by their input terminal or source contact, via a resistor, and which are connected to a common reference potential by the output terminal or drain contact. The control terminals or gate contacts of the transistors are each coupled to the input terminal or source contact of the other transistor via a capacitor. Hereby, a multi vibrator circuit or generally a bistable circuit with two astable switching states is formed, which is implemented to output a sensor alternating signal 24 depending on the environmental temperature 23. Although the above-described temperature measurement circuit 40 is described in connection with the usage of field-effect transistors 42a, 42b and 42c, it should be noted that other transistor types, such as bipolar transistors, could also be used. Here, however, it should be noted that the respective temperature ranges where the temperature sensor can be used change or shift.

Further, it should also be noted that the sensor alternating signal 24 can also be tapped at other contact points within the circuit 40, e.g. at the input terminals of transistors 42a and 42b or at the output terminals of transistors 42a, 42b and 42c.

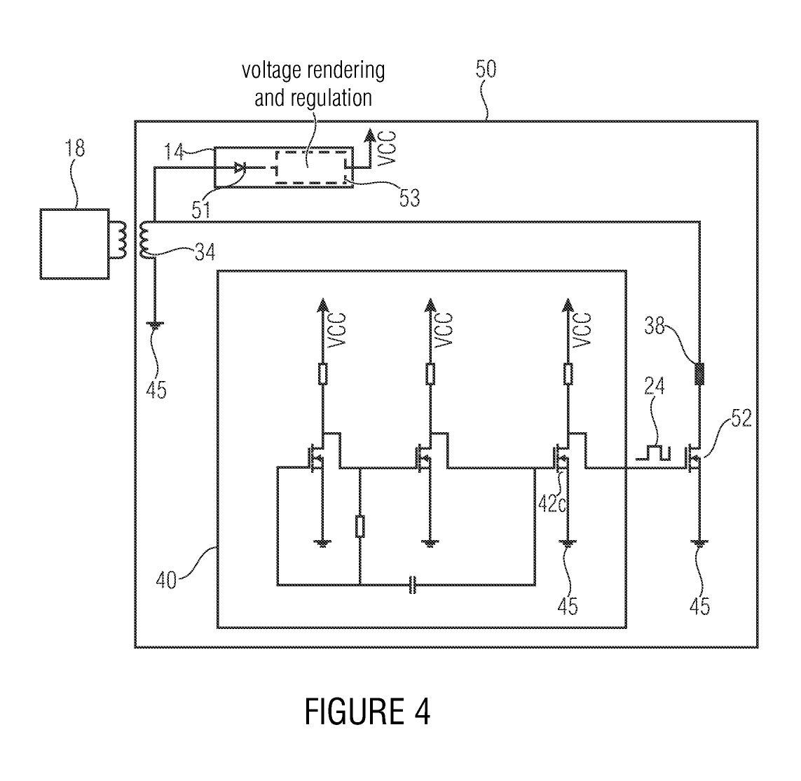

FIG. 4 shows a passive temperature sensor 50 and the reading device 28 according to FIGS. 2a and 2b. The passive temperature sensor 50 comprises the coil 34, the energy rendering element 14, a modulation transistor 52 as switching element and the temperature measurement circuit 40 according to FIG. 3. The temperature measurement circuit 40 and the coil 34 are connected on a first side via a common reference potential 45. Further, on a second side, the coil 34 is connected to the energy supply element 14, which comprises, for example, a rectifier diode 51 or a rectifier and is implemented to provide electric energy or the energy supply signal VCC to the temperature measurement circuit 40. Further, on the second side of the coil 34, the modulation transistor 52 is coupled as coupling element via the load resistor 38. Coupling is effected via the input terminal or source contact of the modulation transistor 52, wherein same is connected to the common reference potential 45 by the output terminal or drain contact. Via the control terminal or gate contact of the modulation transistor 52, the same is connected to the temperature measurement circuit 40 or, more accurately, to the input terminal of the third transistor 42c.

In the following, the functionality of the passive temperature sensor 50 will be discussed. When a magnetic or electromagnetic alternating transmission field exists, the electric energy of the temperature measurement circuit 40 induced in the coil 34 is provided as direct voltage (between the input terminals and output terminals of the three transistors 42a, 42b and 42c) by the rectifier diode 51 of the energy rendering element 14. At sufficient energy supply VCC (e.g. 5 V), the temperature measurement circuit 40 outputs the sensor alternating signal 24 via the input terminal of the third transistor 42c to the modulation transistor 52, wherein the functionality of the temperature measurement circuit 40 corresponds to the one discussed according to FIG. 3. The modulation transistor 52 opens and closes based on the sensor alternating signal 24 and thus influences the load resistance or the impedance value of the same by switching in the load resistor 38 to the coil 34, such that an impact on the magnetic or electromagnetic alternating transmission field is effected. As discussed above, this impact can be detected by the reading device 28.

According to further embodiments, the energy rendering element 14 can comprise a voltage rendering circuit 53 and/or voltage regulation circuit 53 allowing voltage smoothing or voltage regulation.

It should be noted that the passive temperature sensor 50 can be implemented both as electric circuit on a board and as integrated circuit on a common substrate. In the implementation by means of individual components in/on a board, there is the advantage that the individual components have low sensitivity, such that thermal destruction at extremely high temperatures, such as above 250° C., can be avoided. According to a further embodiment, the passive temperature sensor 50 can also be embedded in a non-conductive, weakly conductive or conductive material, such as a carbon fiber composite. For such embedding, correspondingly low frequencies are used for the alternating transmission field. In contrary to this, in an implementation as integrated circuit, there is the advantage that the same can be optimized for the respective application and hence, for example, the overall energy requirement of the passive temperature sensor 50 is lower compared to above stated embodiments, such that operation of the passive temperature sensor 50 in the far field (cf. FIG. 2b) is possible with large distances 29b between temperature sensor 50 and reading device 28. Here, the coil 34 or the coupling element 12 can also be implemented directly as integrated device on a chip.

According to further embodiments, the temperature sensor can comprise a memory that is implemented to store a clearly allocatable identification number. By storing and transmitting the identification number, it is possible to operate several passive temperature sensors simultaneously with one reading device and to thus selectively read out the determined environmental temperature of a uniquely identifiable temperature sensor, wherein the identification number is modulated, for example, onto the alternating transmission field, analogously to a RFID tag.

In the following, the advantages of the above described temperature sensors will be discussed in summary. In embodiments of the above discussed invention, it is advantageous that temperature measurement can be performed wirelessly by means of the passive temperature sensor. Further, it has to be stated that the passive temperature sensor is based on a very simple and hence interference resistant measurement principle, which can be realized without additional components for analog/digital conversion or high-frequency transmission. Here, the determined measurement signal, namely the frequency of the sensor alternating signal, is transmitted directly and is provided to the reading device as measurement quantity. This transmission is not or only minimally affected by embedding into a non-conductive, weakly conductive, conductive or metallic material, such as a carbon fiber composite. When using a conductive or weakly conductive material, low transmission frequencies can be used for compensating the transmission losses. This allows flexible usage of the passive temperature sensor that can be used at almost any location where the environmental temperature is to be determined. In contrary to other wireless temperature measurement methods, no line of sight is necessitated. Due to the structure of the temperature sensor comprising few components, many different form factors are possible, such that the same can be integrated, for example, in semiconductor technologies.

Since the (passive) sensor is energized by the reading device via the high-frequency field, an energy storage, such as a battery, can be omitted. This allows that the sensor (under the prerequisite of a respective structure designed for the temperatures) can also be used at temperatures where conventional energy storages can no longer be used, e.g. >150° or in the range between −41° C. and 200° C.

In the following, substantial aspects of the above described embodiments allowing wireless measurement of the environmental temperature 23 will be illustrated again in summary. The temperature sensor 10, 26 is passive, wherein energy supply is effected wirelessly via an inductively coupled field 20 generated by a reading device 28. Temperature measurement is effected via the switching behavior of field-effect transistors 42a, 42b, 42c, which are connected such that they generate, for example, a square-wave signal 24. At temperature changes, the behavior of the field-effect transistors 42a, 42b, 42c changes, wherein consequently the frequency of the generated square-wave signal 24 changes with the temperature 23. This temperature-dependent signal 24 is transmitted from the sensor 10, 26 to the reading device 28 by means of load modulation (inductively). Here, the current sensor value 24 is modulated onto the field 20 as auxiliary carrier. Hereby, no digitalization and coding of the sensor value 24 takes place, but the frequency of the auxiliary carrier itself is the sensor quantity to be evaluated. At the reading device 28, the auxiliary carrier can be recovered, for example, by simple envelope demodulation and then its frequency can be evaluated correspondingly as measurement value.

The auxiliary carrier frequency is generated with several field-effect transistors 42a, 42b, 42c by an appropriate circuit 16, 40, e.g. a multi vibrator circuit and modulated onto the inductive transmission path with a further field-effect transistor 52 and a load impedance 38. In detail, this means that the output signal 24, e.g., a square-wave signal with a temperature-dependent frequency, is used to control the further field-effect transistor 52. The same switches a load 38 to the secondary coil 34 of the inductive transmission path, which results in the auxiliary carrier with the frequency of the generated square-wave voltage. Thereby, the temperature-dependent frequency is transmitted directly to the reading device 28 by the sensor without previous conversion of the sensor value for the transmission. Here, it should be noted that other ways for generating the frequency signal 24 are also possible. It is important that the frequency of the generated signal 24 is influenced by the environmental temperature 23. The temperature-dependent switching behavior of the field-effect transistors 42a, 42b, 42c is important for determining the frequency. At higher temperatures, these transistors 42a, 42b, 42c switch earlier, i.e. lower gate source voltages are sufficient to connect the channel through. The output frequency of the shown circuit 16, 40 increases with increasing temperature 23. Energy supply of this circuit is ensured by the HF field 20 generated by the reading device 28 by respective rectification 51 and regulation 53 of an energy supply element 14.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A passive temperature sensor with cordless measurement signal transmission, comprising:
a coupling element that is implemented to draw electric energy from a magnetic or electromagnetic alternating transmission field,
an energy rendering element that is implemented to provide an energy supply signal based on the drawn electric energy,
a temperature measurement circuit that is implemented to generate, when supplied with the energy supply signal, a sensor alternating signal a frequency of which depends on an environmental temperature,
a switching element that is implemented to change, based on the sensor alternating signal, a physical characteristic allocated to the coupling element to achieve an impact on the alternating transmission field based on the sensor alternating signal.

2. The passive temperature sensor according to claim 1, wherein the physical characteristic is a load resistance or impedance value of the coupling element.

3. The passive temperature sensor according to claim 1, wherein the switching element is implemented to perform, based on the sensor alternating signal and by changing the load resistance, load modulation of the magnetic alternating transmission field by means of the coupling element.

4. The passive temperature sensor according to claim 1, wherein the switching element is implemented to perform, based on the sensor alternating signal and by changing the impedance value, modulated backscatter of the electromagnetic alternating transmission field by means of the coupling element.

5. The passive temperature sensor according to claim 2, wherein the switching element comprises a modulation transistor that is connected to a first side of the coupling element by its input terminal and connected to a second side of the coupling element by its output terminal,
wherein the modulation transistor is implemented to periodically change the load resistance of the coupling element corresponding to the frequency of the sensor alternating signal that is applied to a control terminal of the modulation transistor.

6. The passive temperature sensor according to claim 1, wherein the coupling element comprises a coil for inductive coupling or an antenna.

7. The passive temperature sensor according to claim 1, wherein the switching element is implemented to influence the alternating transmission field by modulating the sensor alternating signal by means of the coupling element.

8. The passive temperature sensor according to claim 1, wherein the temperature measurement circuit comprises a multi vibrator circuit, a flip flop circuit or an oscillator circuit comprising one or several transistors with a switching behavior depending on the environmental temperature.

9. The passive temperature sensor according to claim 1, wherein the temperature measurement circuit comprises at least two transistors, each connected, via a resistor, to the energy rendering element by an input terminal and connected to a common reference potential by an output terminal, and
wherein at least one control terminal of one of the at least two transistors is coupled to the input terminal of the other of the at least two transistors via a capacitor.

10. The passive temperature sensor according to claim 9, wherein the temperature measurement circuit comprises a third transistor,
wherein a control terminal of the first transistor is coupled to an input terminal of the first transistor via a resistor, a control terminal of the second transistor is coupled to the input terminal of the third transistor and a control terminal of the third transistor is coupled to the input terminal of the second transistor; and
wherein the input terminal of the third transistor is further implemented to supply the sensor alternating signal to the coupling element.

11. The passive temperature sensor according to claim 1, wherein the energy rendering element comprises a rectifier diode or a rectifier, and wherein the coupling element and the temperature measurement circuit comprise a common reference potential.

12. A reading device for passive temperature measurement, comprising:
a read-coupling element that is implemented to provide a magnetic or electromagnetic alternating transmission field and to detect an impact on the alternating transmission field effected by a passive temperature sensor with cordless measurement signal transmission, the sensor comprising:
a coupling element that is implemented to draw electric energy from a magnetic or electromagnetic alternating transmission field,
an energy rendering element that is implemented to provide an energy supply signal based on the drawn electric energy,
a temperature measurement circuit that is implemented to generate, when supplied with the energy supply signal, a sensor alternating signal whose frequency depends on an environmental temperature,
a switching element that is implemented to change, based on the sensor alternating signal, a physical characteristic allocated to the coupling element to achieve an impact on the alternating transmission field based on the sensor alternating signal; and
an evaluator that is implemented to determine temperature information on the environmental temperature of the passive temperature sensor based on the effected impact on the alternating transmission field or to output an output signal based on the effected impact on the alternating transmission field from which the temperature information on the environmental temperature of the passive temperature sensor is derivable.

13. The reading device according to claim 12, wherein the evaluator comprises an envelope modulator that is implemented to determine, based on the detected impact on the alternating transmission field, the frequency of a sensor alternating signal which is modulated onto the magnetic or electromagnetic alternating transmission field by means of load modulation or by means of modulated backscatter.

14. The reading device according to claim 12, wherein the output signal comprises a connection between environmental temperature and output signal corresponding at least section-wise to a predefined connection of a resistance sensor.

15. The reading device according to claim 12, wherein the evaluator is further implemented to determine the temperature information by means of a look-up table,
wherein the look-up table comprises information on an allocation between the frequency of the sensor alternating signal and the measured environmental temperature of the passive temperature sensor for the respective passive temperature sensor.
